(19) United States
(12) Patent Application Publication
(10) Pub. No.: US 2026/0278927 A1
(43) Pub. Date: Sep. 17, 2026

(54) EFFICIENT BATCHING FOR BOUNDING VOLUME HIERARCHY BUILD OPERATIONS

(71) Applicant: Advanced Micro Devices, Inc., Santa Clara, CA (US)

(72) Inventors: Rohan Mehalwal, Orlando, FL (US); Ameer R. Jalil, Orlando, FL (US); Ryan Patrick Kennedy, Boxborough, MA (US); Joshua David Barczak, Santa Clara, CA (US)

(73) Assignee: Advanced Micro Devices, Inc., Santa Clara, CA (US)

(21) Appl. No.: 19/079,916

(22) Filed: Mar. 14, 2025

(51) Int. Cl. G06T 17/00; G06T 15/00; G06T 15/06

(52) U.S. Cl. CPC G06T 17/005; G06T 15/005; G06T 15/06; G06T 2210/12; G06T 2210/21; G06T 2210/52

(57) ABSTRACT

Ray tracing workloads utilize bounding volume hierarchies as an acceleration structure for efficiency. These structures are built for scene geometry. The build operations are batched together and executed in parallel. Such operations are performed in a set of phases separated by synchronization barriers. An important issue with such batching is that BVH build operations have a wide range of execution times. Due to the barriers, slower BVH builds can cause delays in BVH builds that would otherwise complete more quickly. For this reason, instead of batching build requests together regardless of how long they might take to execute, a driver sorts BVH build requests into bins based on a sorting criterion which acts as a proxy for execution time. Because barriers only apply to bins they are in, barriers apply for work that is estimated to complete in a similar amount of time, alleviating the above issue.

### BACKGROUND

In image synthesis, ray tracing is utilized to find a nearest intersection of a given ray with a scene where light propagation is simulated.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail, according to an example;

FIG. 3 illustrates a ray tracing pipeline for rendering graphics using a ray tracing technique, according to an example;

FIG. 4 is an illustration of a bounding volume hierarchy (“BVH”), according to an example;

FIG. 5 illustrates an example two-level BVH;

FIG. 6 illustrates a system for building BVHs in parallel, according to an example;

FIG. 7 illustrates a sequence of operations for building BVHs, according to an example;

FIGS. 8 and 9 illustrate operations for building BVHs, according to an example; and

FIG. 10 is a flow diagram of a method for building bounding volume hierarchies, according to an example.

### DETAILED DESCRIPTION

Ray tracing is a rendering technique whereby rays are cast into a scene and pixels of a render target are colored based on which objects the rays intersect. To speed such operations up, a ray tracing system typically builds an acceleration structure such as a bounding volume hierarchy (“BVH”). Such a structure has a hierarchy of levels, where each level can include nodes. Each non-leaf node has references to other nodes as well as a bounding volume that encloses the geometry of those other nodes. When traversing the BVH, the ray is tested for intersection with such bounding volumes and traversal to the nodes referenced does not occur if the ray does not intersect the bounding volumes. Leaf nodes include references to primitives. Depending on the result of an intersection test between a ray and a primitive, the ray tracing pipeline causes shader work to be performed.

To use ray tracing to render a scene, BVHs must be built from the geometry to be rendered. Typically, many BVH build operations are required to render a scene, and thus care must be taken to perform BVH build operations efficiently.

An application sends many requests to a driver to build BVHs. The driver batches these requests, collecting them and launching them for execution on a graphics processing unit (“GPU”) after a delay. This batching allows the operations to take advantage of the parallelism of the GPU—launching multiple BVH build operations together allows them to execute in parallel. Further, BVH build operations on the GPU are launched as a set of phases, each separated by a barrier. All work for a phase prior to a barrier must complete before work after the barrier can begin.

An important issue with this configuration is that, BVH builds have a wide range of execution times, dependent on, for example, the number of primitives for which BVHs are being built. Due to the barriers, this means that slower BVH builds can cause delays in BVH builds that would otherwise complete more quickly. For this reason, techniques are provided herein to alleviate this issue. Instead of batching build requests together regardless of how long they might take to execute, a driver sorts BVH build requests by a sorting criterion which acts as a proxy for execution time. The driver then places these sorted BVH build requests into respective work queues in the GPU, along with appropriate barriers, which only apply to work within the same work queue. By sorting the work in this manner, barriers apply for work that is estimated to complete in a similar amount of time, meaning that work that completes in a very long amount of time generally does not delay work that completes in a much smaller amount of time.

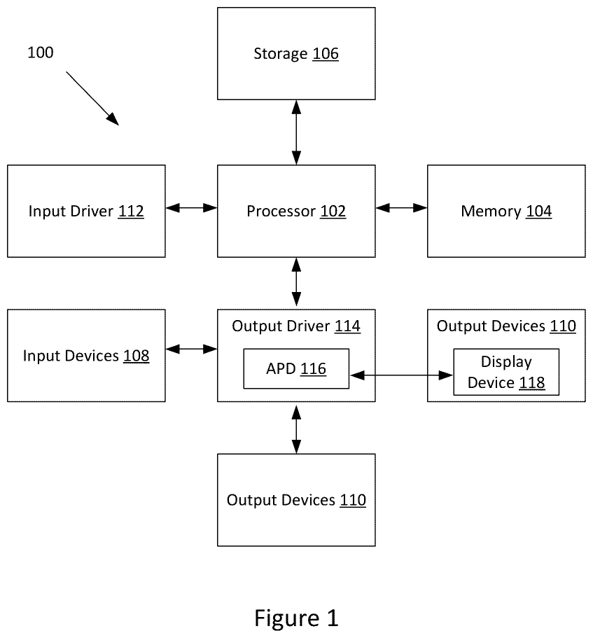

FIG. 1 is a block diagram of an example device 100 in which one or more features of the disclosure can be implemented. The device 100 can include, for example, a computer, a gaming device, a handheld device, a set-top box, a television, a mobile phone, server, a tablet computer or other types of computing devices. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid-state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display device 118, a display connector/interface (e.g., an HDMI or DisplayPort connector or interface for connecting to an HDMI or Display Port compliant device), a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 116 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a parallel processing paradigm, such as a single-instruction-multiple-data (“SIMD”) paradigm or a single-instruction-multiple-threads (“SIMT”). Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a parallel processing paradigm may perform the functionality described herein. Alternatively, it is contemplated that computing systems that do not perform processing tasks in accordance with a parallel processing paradigm can also perform the functionality described herein. The APD 116 includes APD memory 139, which is available for the compute units 132, and local data share memory 137, which is local to each compute unit 132 and is available to its respective compute unit 132.

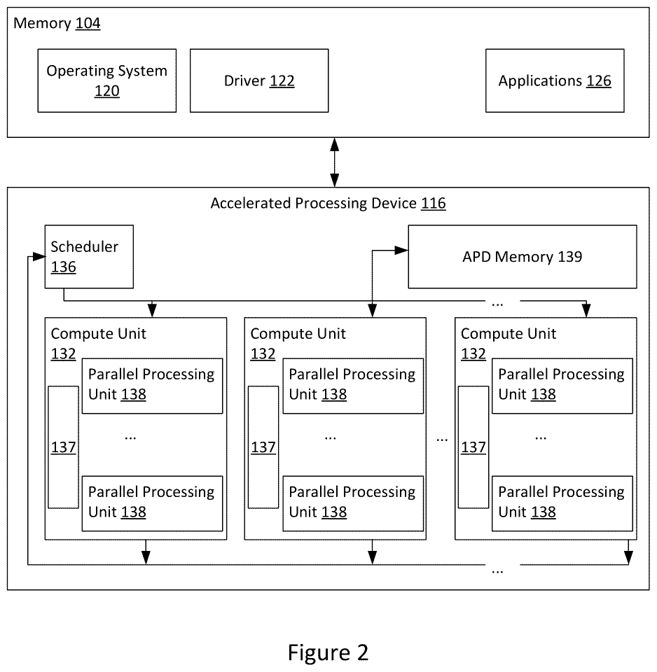

FIG. 2 is a block diagram of aspects of device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the parallel processing units 138 discussed in further detail below) of the APD 116.

The APD 116 executes commands and programs for selected functions, such as graphics operations and non-graphics operations that are or can be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more parallel processing unit 138 that perform operations at the request of the processor 102 in a parallel manner according to a parallel processing paradigm, such as SIMD or SIMT. In such paradigms, multiple processing elements execute the same instruction across multiple data elements or threads. The multiple processing elements share a single program control flow unit and program counter and thus execute the same program but are able to execute that program with or using different data. In one example, each parallel processing unit 138 includes sixteen lanes, where each lane executes the same instruction at the same time as the other lanes in the parallel processing unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program or kernel that is to be executed in parallel according to the parallel processing paradigm employed. For example, in a SIMD architecture, multiple work-items execute the same instruction simultaneously on different data elements. Work-items can be executed simultaneously as a “wavefront” on a parallel processing unit 138, where each work-item executes the same instruction with different data and where different work-items can execute a different control flow path through the use of predication. In a SIMT architecture, work-items correspond to threads that can be executed simultaneously on the parallel processing unit 138, where different threads can execute different control flow paths. Threads are grouped into “warps” or “wavefronts”, which are scheduled or executed together.

For the purposes of this description, the term “wavefront” will be used, but it should be understood that this term broadly describes work-items that can be executed simultaneously and is inclusive of both “wavefronts” and “warps.” One or more wavefronts are included in a “work group,” which includes a collection of work-items designated to execute the same program. A work group can be executed by executing each of the wavefronts that make up the work group. In alternatives, the wavefronts are executed sequentially on a single parallel processing unit 138 or partially or fully in parallel on different parallel processing unit 138. Wavefronts can be thought of as the largest collection of work-items that can be executed simultaneously on a single parallel processing unit 138. Thus, if commands received from the processor 102 indicate that a particular program is to be parallelized to such a degree that the program cannot execute on a single parallel processing unit 138 simultaneously, then that program is broken up into wavefronts which are parallelized on two or more parallel processing units 138 or serialized on the same parallel processing unit 138 (or both parallelized and serialized as needed). A scheduler 136 performs operations related to scheduling various wavefronts on different compute units 132 and parallel processing units 138.

The parallelism afforded by the compute units 132 is suitable for graphics related operations such as pixel value calculations, vertex transformations, and other graphics operations and non-graphics operations (sometimes known as “compute” operations). Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

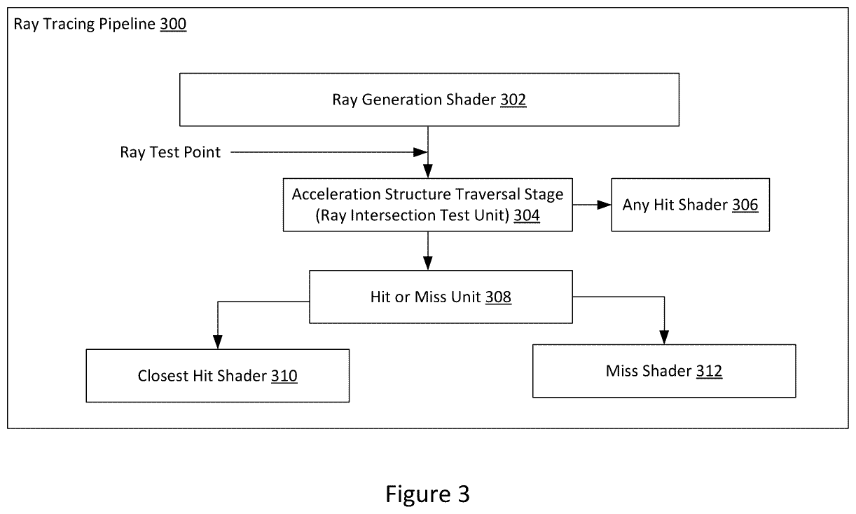

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

The various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

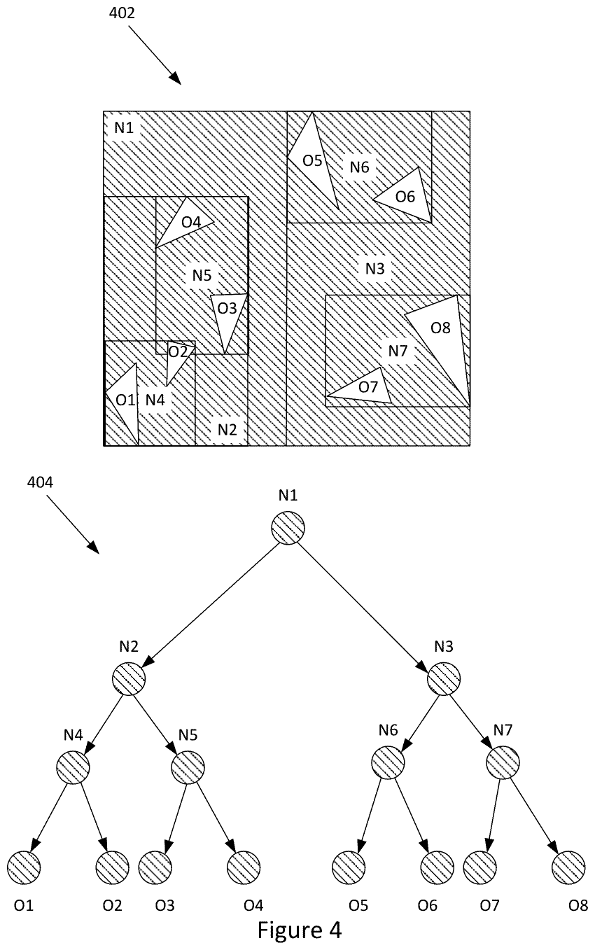

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the test for that non-leaf node fails. In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that N₆ succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

The BVH for a scene is often a two-level BVH—a top-level BVH includes nodes having bounding boxes that bound larger structures such as objects. Bottom-level BVHs include detailed geometry for these larger structures. Organization in this manner allows for reuse of geometry through a scene without duplication of information. More specifically, special nodes in the top-level BVH referred to as instance nodes reference bottom-level BVHs. Multiple instance nodes can refer to the same bottom-level BVH. Further, each instance node can include its own instance transform, which defines modifications to the geometry of the referenced bottom-level BVH. Such modifications can include translation (e.g., position change), scale, shear, orientation adjustment, or other adjustments.

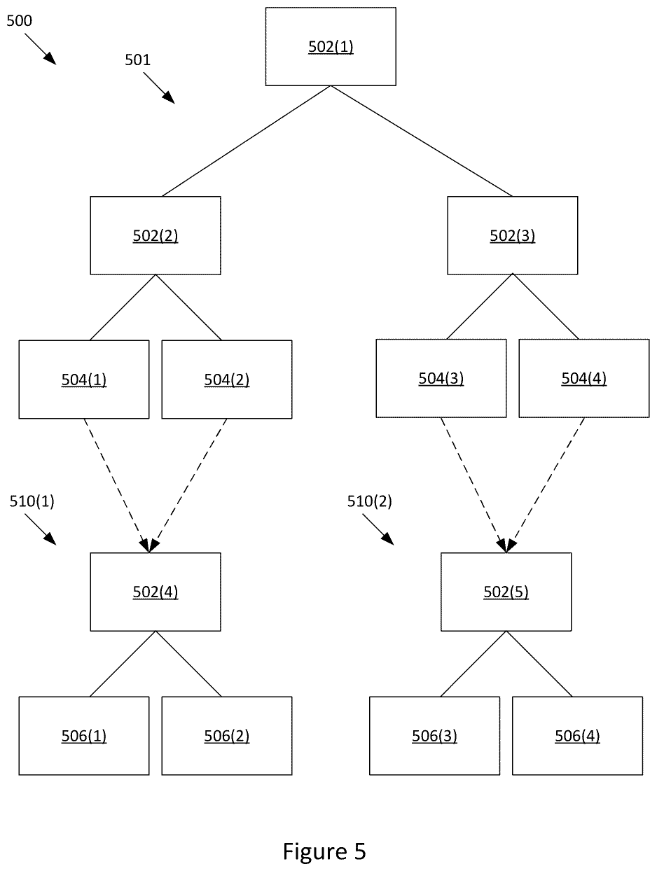

FIG. 5 illustrates an example two-level BVH 500. The two-level BVH 500 includes a top-level BVH 501. The top-level BVH includes non-leaf nodes 502 and instance nodes 504. Each instance node includes an instance transform and a pointer to a bottom-level BVH. In the example, instance nodes 504(1) and 504(2) have pointers that point to bottom-level BVH 510(1) and instance nodes 504(3) and 504(4) have pointers to bottom-level BVH 510(2).

For traversal of the BVH, if the ray tracing pipeline 300 arrives at the non-leaf node 504(1) (e.g., because the ray tracing pipeline 300 determines that a ray intersects the bounding volume of non-leaf node 502(2)), then the ray tracing pipeline 300 follows the pointer to bottom-level BVH 510(1). The ray tracing pipeline 300 then traverses that bottom-level BVH 510(1), determining what work to perform (e.g., shading work such as any hit shader or closest hit shader) based on which leaf nodes 506(1) the ray intersects. Such traversal is performed with the instance transform specified by instance node 504(1). Similar operations would occur for instance node 504(2).

As can be seen, for a given two-level BVH 500, multiple bottom-level BVHs are present. In order to render a scene, the BVH (two-level BVH 500) typically builds each of these bottom-level BVHs, either by adjusting an earlier version of that BVH (a “refit”), or from “scratch” by referring to the underlying geometry (e.g., primitives) (a “rebuild”). Because the bottom-level BVHs are independent—no node of any bottom-level BVH 510 includes a pointer to or otherwise depends on any other bottom-level BVH 510—it is possible to build these BVHs in parallel.

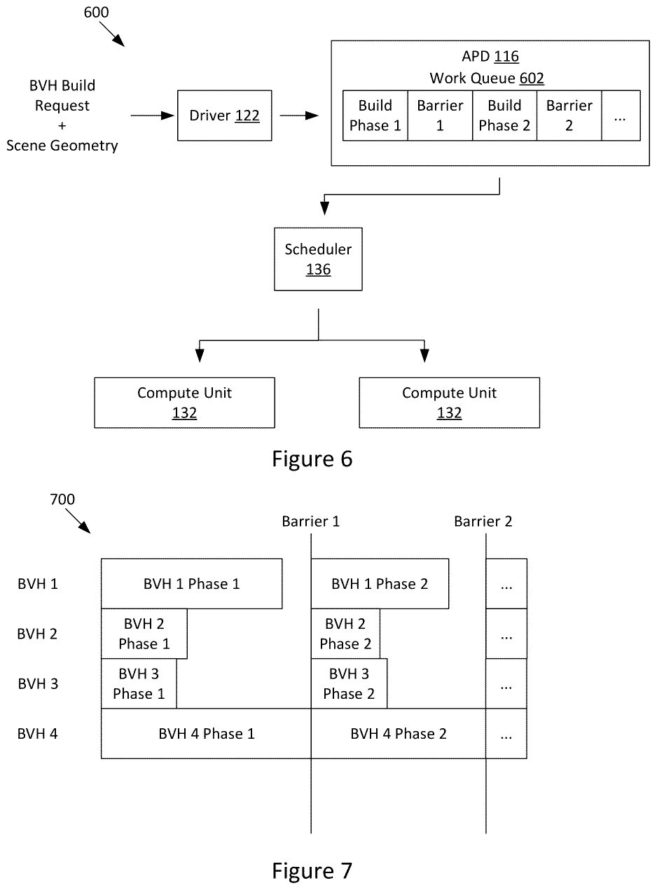

FIG. 6 illustrates a system 600 for building BVHs in parallel, according to an example. In this system 600, a driver 122 receives requests to build BVHs, as well as scene geometry for which the BVH is to be generated. The scene geometry includes a number of different portions of scene geometry, and for each such portion, a bottom-level BVH will be generated. In some examples, each such portion of scene geometry is an object, and each BVH build request requests a BVH build for one of these objects.

The driver 122 generates work to be placed into a work queue 602 of the APD 116. In particular, the driver 122 receives multiple BVH build requests with accompanying scene geometry and batches these requests so that work to satisfy the requests can be launched in parallel on the APD 116, taking advantage of the performance benefits of parallel execution on that platform. To perform these batched requests, the driver 122 generates work. The work generated includes a set of kernel queue packets, and a set of barriers. A kernel queue packet is an indication to perform a certain amount of specified work. A barrier is a marker that indicates that no work past the barrier should begin until all work prior to the barrier is complete.

The process of building a BVH is divided into phases. The driver 122 inserts kernel queue packets into the work queue 602 to perform each such phase for each BVH to be built. In general, each phase is a portion of work for building a BVH. A subsequent phase is dependent on the results of an earlier phase, and thus the driver 122 inserts barriers between the phases. Each phase shown in FIG. 6 represents work for building multiple BVHs. In some examples, each illustrated phase is one kernel packet that launches a kernel. This kernel is programmed to perform a single phase of work for building BVHs. In addition, this kernel is provided, as input, a number of different portions of geometry, so that the kernel builds multiple BVHs, one for each portion. Thus, the block “build phase 1” represents work for phase 1 of building a set of BVHs, the block “build phase 2” represents work for phase 2 for building the set of BVHs, and so on.

Example phases include a phase for generating Morton codes, a phase for sorting the Morton codes, a phase for constructing BVH topology, and a phase for conversion of the BVH topology to a hardware BVH format.

Due to the presence of barrier 1, no phase 2 work for building any BVH of the set of BVHs can begin until each phase 1 for building all BVHs of the set can complete. A consequence is that some BVHs are complete in phase 1 much earlier than other BVHs, but cannot proceed to phase 2 until all BVHs have completed phase 1, resulting in significant delays.

FIG. 7 illustrates a sequence of operations 700 for building BVHs, according to an example. The sequence of operations includes building four different BVHs in multiple phases. In addition, these operations are performed together as a set of operations, meaning that all work of this set before a barrier must complete before work of the set after the barrier begins.

As can be seen, BVH 3 and BVH 2 complete phase 1 operations much earlier than BVH 4 and BVH 1. However, due to the barrier (“barrier 1”), BVH 2 and BVH 3 must wait until BVH 1 and BVH 4 complete phase 1 in order to proceed to phase 2. Similarly, in phase 2, BVH 2 and BVH 3 complete much earlier than BVH 1 and BVH 4, resulting in a similar problem.

To alleviate these issues, in some implementations, the driver 122 sorts build operations for BVHs based on a sorting criterion that acts as a proxy for the estimated time to completion of such operations. More specifically, as stated above, the driver 122 “batches” or collects requests to build BVHs and schedules those requests together. In the configuration of FIGS. 6 and 7, a batch is generated without considering the estimated time to completion. For example, the driver 122 receives a set of BVH build requests and groups these build requests together to generate work for a work queue 602 of the APD 116.

In some examples, the work queue 602 is an asymmetric hardware work queue. Such a queue has the property that once work is placed into that queue, the scheduler 136 is permitted to schedule and thus trigger execution of any item from that work queue 602, as long as the barrier conditions are met. In other words, the scheduler 136 does not have to schedule in order of placement of work in the queue. In the example described herein, the driver 122 may batch the BVH build requests and parallelize those requests to the degree possible, such that one entry in the work queue 602 includes build operations for multiple BVHs. However, it is possible for such a batch to result in the generation of multiple entries in the work queue 602 per phase, where the scheduler schedules work for such entries opportunistically, observing the barrier. In some examples, work in a work queue 602 has the property that the scheduler 136 observes barriers for work within that queue. However, different queues do not have such a limitation. That is, the scheduler 136 does not observe barriers in one work queue 602 for work in a different work queue 602.

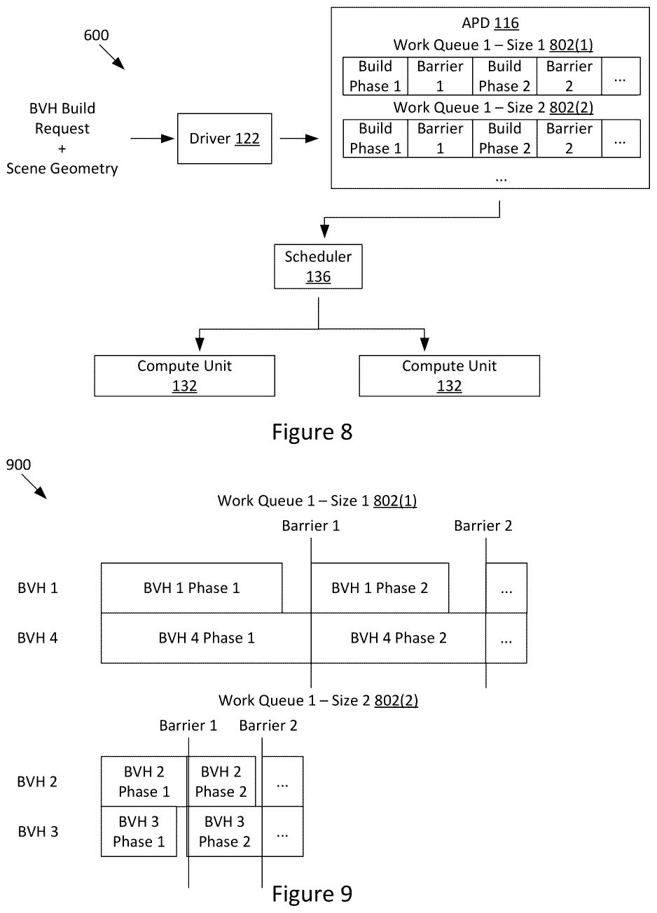

FIGS. 8 and 9 illustrate operations for building BVHs, according to an example. In particular, FIG. 8 illustrates placing work into work queues 802 (which are similar to work queues 602 of FIG. 6) and subsequent execution of that work on compute units 132 of an APD 116. In particular, the driver 122 sorts the build requests into bins based on a sorting criterion that acts as a proxy for estimated phase completion time. Each bin is associated with a particular sorting criterion value. In some examples, the size of the geometry for the BVH build request, where the size is defined by the number of primitives in that geometry, comprises a measure of the estimated phase completion time. In other words, in some examples, the driver 122 sorts the build requests based on the number of primitives in the build requests. In other examples, the sorting criterion includes other aspects such as BVH build algorithm or type of BVH build (e.g., refit or rebuild).

In greater detail, in an example, each BVH build request is provided with an associated set of geometry (e.g., for an object corresponding to a bottom-level acceleration structure). The driver 122 analyzes that set of geometry to determine which bin to place the work to build a BVH for that set of geometry into. The driver 122 repeats this process for a number of BVH build requests to obtain a set of bins, each containing a number of BVH build requests. The driver 122 assigns each bin to a different work queue 802. For each work queue, the driver 122 stores entries corresponding to work of the corresponding bin. This work includes work for each phase of the BVH build and a barrier in between each phase. As a result of these operations, each work queue 802 has work for building BVHs for a corresponding bin, and not for any other bin. Stated differently, as a result of the operations described above, there are multiple work queues 802, each including work for a different “bin.” Each bin is associated with a particular range of BVH sizes, where these sizes are defined by number of primitives in the BVH. This configuration allows the barriers for the BVH build operations for BVHs of very different sizes to operate independently, reducing the need for operations that build small BVHs to wait for large BVHs to complete.

FIG. 9 illustrates operations 900 associated with processing the contents of the work queues 802 illustrated in FIG. 8, according to an example. In FIG. 9, operations for building BVH 1 and BVH 4 have been placed into work queue 1 802(1), and operations for building BVH 2 and BVH 3 have been placed into work queue 2 802(2).

Regarding work queue 1 802(1), no operation for phase 2 can begin until all phase 1 operations in that work queue 802(1) have completed. Thus, though phase 1 for BVH 1 completes before phase 1 for BVH 4, neither BVH 1 nor BVH 4 can proceed to phase 2 until BVH 4 has completed phase 1. Once that occurs, BVH 1 and BVH 4 proceed to phase 2 as shown.

Regarding work queue 2 802(2), a similar operation occurs for BVH 2 and BVH 3. However, because these operations take a similar amount of time, which is considerably less time than phase 1 completes in work queue 1 802(1), sorting the BVH build operations as described above allows both BVH 2 and BVH 3 to proceed to phase 2 before either would proceed to phase 2 if such sorting did not occur. For example, in FIG. 7, BVH 2 and BVH 3 both must wait for BVH 4 to complete phase 1 before proceeding.

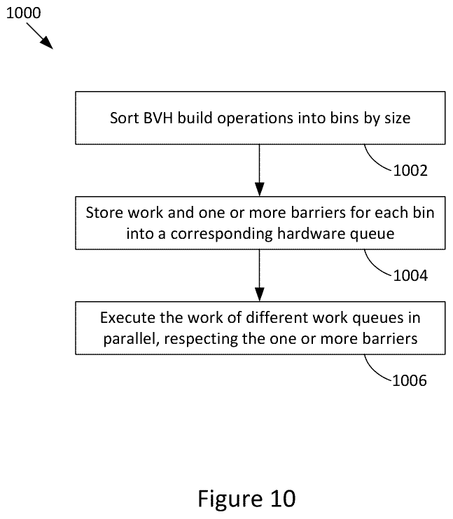

FIG. 10 is a flow diagram of a method 1000 for building bounding volume hierarchies, according to an example. Although described with respect to the system of FIGS. 1-9, those of skill in the art will understand that any system configured to perform the steps of the method 1000 in any technically feasible order falls within the scope of the present disclosure.

At step 1002, a driver 122 sorts BVH build operations into bins by size. More specifically, BVH build operations are requests made by an entity (such as an application) to build a BVH for geometry. In some examples, the geometry is an object that is represented in a bottom-level acceleration structure of a two-level acceleration structure. In some examples, an application requests many such BVHs to be built, as there are many objects in a scene. The driver 122 “batches” these requests, meaning that the driver 122 buffers the requests, rather than immediately launching work to satisfy the requests on the APD 116. This batching helps take advantage of the parallelism provided by the APD 116. As described with respect to FIGS. 6-7, grouping together BVH build operations without considering the size (e.g., number of primitives involved) of the build operations can lead to a result where very quick build operations are waiting for much slower build operations. As a result, the driver 122 sorts the BVH build operations based on size.

In some examples, the driver 122 designates a set of bins, where each bin corresponds to a range of BVH sizes (e.g., a range of numbers of primitives involved in the BVH build). In some examples, the ranges are dependent on the BVH builds being sorted-for example, the bins span ranges from the lowest sized bin to the highest sized bin. Sorting the BVH build requests includes determining which bin each BVH build request is to be included within. More specifically, each bin has an associated range of sizes and the driver 122 determines which range of sizes a BVH build falls within. The BVH build is thus determined to fall within that particular bin.

At step 1004, the driver 122 stores work and one or more barriers for each bin into a corresponding work queue 602 of the APD 116. More specifically, each bin is associated with a particular work queue 602, and each bin has an associated set of BVH build requests. The driver 122 stores work to process each build request for a bin into the work queue 602 for that bin. Such work includes work to execute each phase of the build request as well as a barrier operation between the phases. As described above, the barrier operation causes the APD 116 to prevent work in the work queue 602 after the barrier operation from beginning until all work prior to the barrier has completed. Barrier operations impose this limitation for work within the same work queue 602 as the barrier operation, and not for work in any other work queue 602. Because the bins are assigned to different work queues 602, the barriers operate for work in the same bins, but not for other bins.

At step 1006, the APD 116 executes the work of the different work queues 602 in parallel, respecting the barriers inserted by the driver. In various examples, this execution occurs as follows. For each phase, a work queue 602 stores one or more kernel queue packets. Each kernel queue packet is an indication of a kernel invocation that is to be launched. A kernel invocation is an instance of execution of a kernel that defines which program to execute (e.g., which compute shader program, also sometimes referred to as a “kernel”), as well as other parameters for that execution, such as specifying what the inputs to the program are and where the outputs to be placed. In the example described herein, the work for a particular phase indicates that a kernel (shader program) to perform the operations for that phase is to execute. Further, that work indicates the inputs to that work—specifically, data associated with one or more specific BVHs that are to be built. In some examples, for a first phase, this data includes the geometry (e.g., vertices, mesh identifiers, and other geometry information) for which a BVH is to be built. In some examples, for any particular work queue 602, this geometry includes geometry for multiple different bottom-level BVHs, as multiple such BVHs are to be built. Further, any particular work queue 602 includes work for building BVHs having sizes (numbers of primitives) that fit within the range specified the bin assigned to that work queue 602. Execution of the work in a work queue 602 also involves observing the barriers within that work queue. To do this, the APD 116 does not launch any work considered to be after a barrier until all work considered to be prior to the barrier is complete. In any particular work queue, barrier separate the different phases. Thus, all work for a particular phase must be complete before work for the next phase can begin. Moreover, as each phase includes work to build multiple BVHs, work in one phase for all BVHs in a work queue 602 waits to begin until work for the previous phase for all such BVHs in that work queue 602 are complete. However, as stated above, because bins are assigned to different work queues 602 and because the barriers are observed for work within a work queue 602 but not between work queues, work for subsequent phases in one work queue 602 does not need to wait for work from earlier phases in a different work queue 602.

It should be understood that, within a work queue 602, the work to build a BVH in a particular phase is performed in parallel. In some examples, the APD 116 executes a requested kernel as a set of workgroups. Each workgroup is in turn executed as a plurality of wavefronts, and each wavefront executes multiple work-items in parallel (e.g., in a SIMD or SIMT manner). In some examples, each different work-item performs work for one BVH, and thus a wavefront performs work for a phase for multiple BVHs in parallel. In other examples, the correlation between work-item and BVH is not one-to-one, and thus in various examples, multiple work-items cooperate to build one BVH or multiple BVHs are built per work-item. In some examples, work for a phase completes when all kernels of that phase are complete, and when thus all workgroups and wavefronts for all such kernels (for that phase) are complete. Once this occurs, the subsequent barrier is considered to be satisfied and the APD 116 (e.g., via the scheduler 136) launches work subsequent to the barrier (e.g., phase 2 if phase 1 has completed). Launching this work includes launching the kernel(s) for that subsequent phase, which then results in the workgroups and wavefronts executing for that phase.

Above, it is stated that the driver 122 sorts incoming BVH build requests based on size of the BVH being built. However, this is not the only criterion that sorting may be based on. More specifically, in some examples, sorting is based on the specific algorithm being used to build the BVH, with the driver 122 designating one work queue 602 for each algorithm. In other examples, sorting is based on the type of operation being performed for the BVH build, where the type can be a rebuild or a refit. A rebuild creates a new BVH from scratch, from geometry. A refit maintains the topology of a BVH (where the topology is defined by the nodes and connectivity between nodes) but modifies numerical elements of the BVH defined by the topology. In an example, a refit operation modifies the bounding volumes in each node to accommodate modified geometry. For example, in a leaf node that includes pointers to multiple triangles, if the positions of the triangles change from a previous incarnation of the leaf node, such that the bounding volume that bounds all such triangles changes, then the refit operation updates this bounding volume to take into account the updated geometry. In some examples, the driver 122 sorts by multiple above the above considerations-for example, sorting by both size and algorithm, both algorithm and type, both type and size, or all three. In such an example, each different combination of size range and algorithm or type would be assigned to its own bin and thus its own work queue 602. Herein, the term “sorting criterion” is used generally to refer to the criterion upon which the driver 122 sorts BVH build requests into bins. In various examples, the sorting criterion is one of the size, algorithm, or type of BVH build operations, or is a combination of such item. In various examples, sorting BVH build operations by sorting criterion means placing each BVH build operation into a bin based on the value for each element of the sorting criterion. For example, if the sorting criterion is size, then each size range is assigned a bin. If the sorting criterion is size and algorithm, then each combination of size range and algorithm has a bin. If the sorting criterion is size and type, then each combination of size range and type has a bin, and so on.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the compute units 132, the SIMD units 138, the ray tracing pipeline 300, including the ray generation shader 302, acceleration structure traversal stage 304, any hit shader 306, hit or miss unit 308, closest hit shader 310, or the miss shader 312, may be implemented as a general purpose computer, a processor, a processor core, or in digital circuitry or analog circuitry, or as a program, software, or firmware, stored in a non-transitory computer readable medium or in another medium, executable by a general purpose computer, a processor, or a processor core. Anything described as “circuitry” could alternatively be implemented as programmable hardware, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). * * *

What is claimed is:

1. A method comprising:
sorting a set of bounding volume hierarchy (“BVH”) build operations into bins based on a sorting criterion;
for each bin, inserting work and one or more barriers into a work queue corresponding to the bin; and
executing the work inserted into the work queues.

2. The method of claim 1, wherein the work includes, for a BVH build operation, a set of phases separated by the one or more barriers.

3. The method of claim 2, wherein within each work queue, a barrier causes work after the barrier to wait to begin until work before the barrier is complete.

4. The method of claim 2, wherein a barrier of a first work queue has no effect on work of a second work queue.

5. The method of claim 1, wherein the set of BVH build operations is received from an application.

6. The method of claim 1, wherein the sorting criterion includes one or more of a size of the BVH build operations, an algorithm of the BVH build operations, or a type of the BVH build operations.

7. The method of claim 1, wherein the work inserted into each bin comprises a kernel invocation that describes a shader program to execute.

8. The method of claim 7, wherein the kernel invocation causes execution of a kernel including one or more workgroups and one or more wavefronts.

9. The method of claim 1, wherein the BVH build operations of the set of BVH build operations are each either a rebuild operation or a refit operation.

10. A system comprising:
a memory configured to store bounding volume hierarchy (“BVH”) data; and
a processor configured to:
sort a set of BVH build operations into bins based on a sorting criterion;
for each bin, insert work and one or more barriers into a work queue corresponding to the bin; and
execute the work inserted into the work queues to generate the BVH data.

11. The system of claim 10, wherein the work includes, for a BVH build operation, a set of phases separated by the one or more barriers.

12. The system of claim 11, wherein within each work queue, a barrier causes work after the barrier to wait to begin until work before the barrier is complete.

13. The system of claim 11, wherein a barrier of a first work queue has no effect on work of a second work queue.

14. The system of claim 10, wherein the set of BVH build operations is received from an application.

15. The system of claim 10, wherein the sorting criterion includes one or more of a size of the BVH build operations, an algorithm of the BVH build operations, or a type of the BVH build operations.

16. The system of claim 10, wherein the work inserted into each bin comprises a kernel invocation that describes a shader program to execute.

17. The system of claim 16, wherein the kernel invocation causes execution of a kernel including one or more workgroups and one or more wavefronts.

18. The system of claim 10, wherein the BVH build operations of the set of BVH build operations are each either a rebuild operation or a refit operation.

19. A non-transitory computer-readable medium storing instructions that, when executed by a processor, cause the processor to perform operations comprising:
sorting a set of bounding volume hierarchy (“BVH”) build operations into bins based on a sorting criterion;
for each bin, inserting work and one or more barriers into a work queue corresponding to the bin; and
executing the work inserted into the work queues.

20. The non-transitory computer-readable medium of claim 19, wherein the work includes, for a BVH build operations, a set of phases separated by the one or more barriers.
